(19) United States
(12) Patent Application Publication
(10) Pub. No.: US 2013/0107529 A1
(43) Pub. Date: May 2, 2013

(54) LIGHT FIXTURE AND LIGHTING DEVICE USING THE SAME

(71) Applicants: CHIH-MING LIAO, TAOYUAN COUNTY (TW); CHIH SUNG CHEN, NEW TAIPEI CITY (TW); CHI-FU CHUANG, NEW TAIPEI CITY (TW); JIH-SHENG HUANG, TAOYUAN COUNTY (TW)

(72) Inventors: CHIH-MING LIAO, TAOYUAN COUNTY (TW); CHIH SUNG CHEN, NEW TAIPEI CITY (TW); CHI-FU CHUANG, NEW TAIPEI CITY (TW); JIH-SHENG HUANG, TAOYUAN COUNTY (TW)

(73) Assignee: ENLIGHT CORPORATION, TAOYUAN COUNTY (TW)

(21) Appl. No.: 13/531,499

(22) Filed: Jun. 23, 2012

(30) Foreign Application Priority Data
Oct. 26, 2011 (TW) 100220120

(51) Int. Cl. F21V 21/00

(52) U.S. Cl. 362/249.01

(57) ABSTRACT

The instant disclosure provides a lighting device, which includes a fixture body having a first receiving space formed therein; at least one light-emitting unit disposed on the fixture body and accommodated in the first receiving space; at least one optical unit disposed on the fixture body in the first receiving space configured to receive light emitted by the light-emitting unit; and at least one elastic module arranged between the optical unit and the fixture body, where the elastic module provides the buffering and anti-shock effect.

### BACKGROUND OF THE INSTANT DISCLOSURE

1. Field of the Instant Disclosure

The instant disclosure relates to a light fixture; in particular, to a light fixture whose light-emitting units can be prevented from damage and a lighting device thereof.

2. Description of Related Art

Along with the advance of technology, the structural design and the outer appearance of the light fixtures are improved accordingly and new lighting products are being researched unceasingly. In particular, as the light emitting diodes (LED) have advantages such as a smaller volume, lesser power consumption, lower temperature, higher brightness and etc., the LED is widely applied to replace the light bulb, the lamp house and etc. Furthermore, as the LED is a type of point light source, therefore the LED is often accompanied by light-guiding plates to achieve an even light distribution and a softer light emission.

However, as the lighting products of the LED are progressing towards minimization, the LED units within the lighting products may be damaged due to the accumulation of the heat. For instance, the heat produced from the LED may deform the light-guiding plates or resulting in other problems. Furthermore, the light-guiding plates may expand due to the heat, where the increased volume may deal impact to damage the LED units within the minimized lighting products. Therefore, malfunctioning the LEDs to decrease the service life of the lighting products.

To address the above issues, the inventor strives via industrial experience and academic research to present the instant disclosure, which can effectively improve the limitations described above.

### SUMMARY OF THE INSTANT DISCLOSURE

The object of the instant disclosure is to provide a light fixture which utilizes a specifically designed elastic module to provide a buffering effect between the optical unit and the light-emitting unit. Hence, the damage to the light-emitting unit can be reduced.

The instant disclosure provides a light fixture, which includes a fixture body which has a first receiving space formed therein; at least one light-emitting unit disposed on the fixture body and accommodated in the first receiving space; at least one optical unit disposed on the fixture body in the first receiving space configured to receive light emitted by the light-emitting unit; and at least one elastic module arranged between the optical unit and the fixture body.

The instant disclosure provides a lighting device, which includes a plurality of light fixtures, where each of the light fixture includes: a fixture body having a first receiving space defined therein; at least one light-emitting unit disposed on the fixture body and accommodated in the first receiving space; at least one optical unit disposed on the fixture body in the first receiving space configured to receive light emitted by the light-emitting unit; at least one elastic module arranged between the optical unit and the fixture body; and a plurality of fastening units connecting the fixture bodies of the plurality of lighting devices.

The instant disclosure utilizes the elasticity, the flexibility, and the anti-vibration characteristic of the elastic module to form a buffering space for the optical unit. Specifically speaking, after the optical unit is expanded due to the heat, the elastic module can receive the increased volume of the optical unit. Therefore, the optical unit and the light-emitting unit can be prevented from establishing contact to further prevent the production of friction. Hence, the damage to the light-emitting unit from the optical unit can be reduced to increase the service life of the light fixture.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows an exploded perspective view of a light fixture of the instant disclosure;

FIG. 2 shows another exploded perspective view of the light fixture of the instant disclosure;

FIG. 3 shows a cross-sectional view of the light fixture of the instant disclosure;

FIG. 3A shows an enlarged view of the A portion of FIG. 3.

FIG. 4 shows a cross-sectional view of a partial of the light fixture of the instant disclosure;

FIG. 5 shows a perspective view of the light fixture of the instant disclosure.

### DETAILED DESCRIPTION OF THE PREFERRED EMBODIMENTS

The instant disclosure discloses a light fixture which utilizes an elastic module to provide the buffering effect for reducing the damage rate of the light-emitting from the optical units. In particular, for reducing the damage due to the heat expansion from the optical units. The light fixture of the instant disclosure can be formed individually or as a component for assembly to be applicable in all occasions.

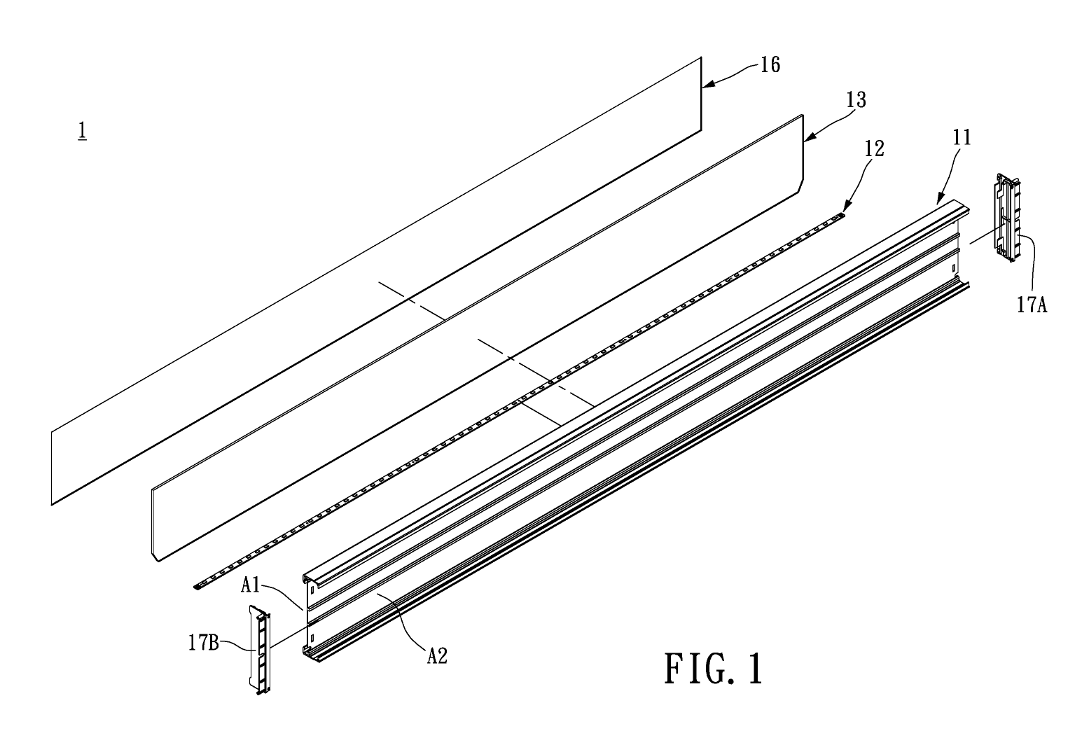

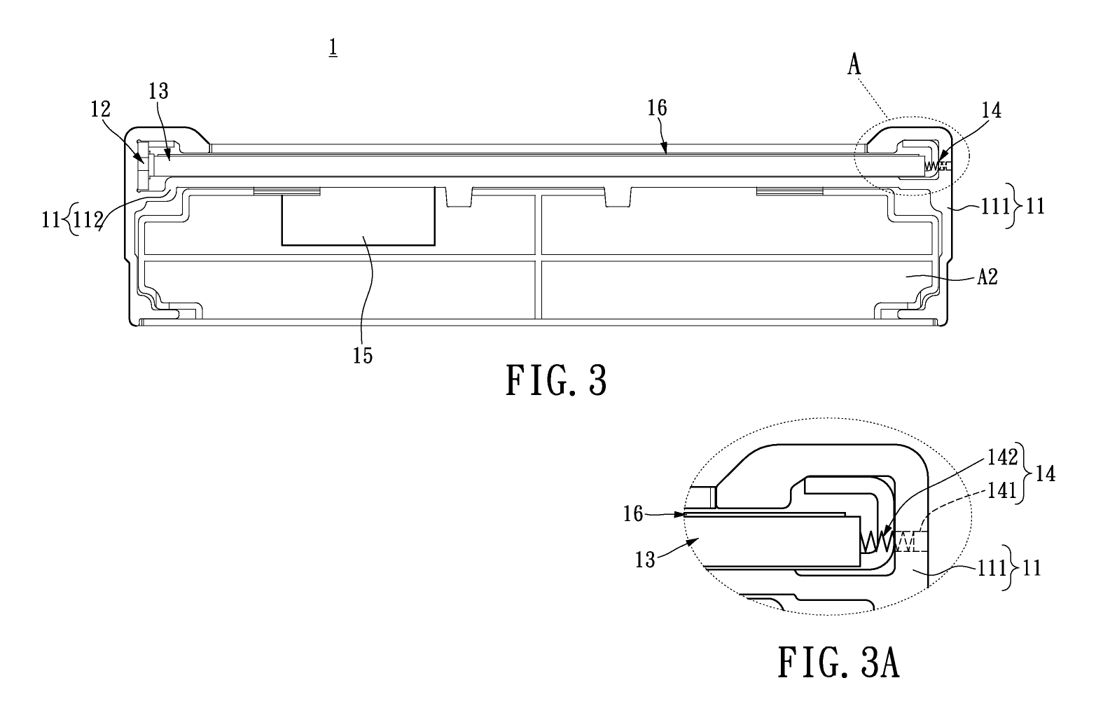

Please refer to FIGS. 1 and 3 which show a perspective view of the light fixture 1 of the instant disclosure. The light fixture 1 includes a fixture body 11, a light-emitting unit 12, an optical unit 13 and an elastic module 14. The fixture body 11 is utilized to load and stabilize the components including the light-emitting unit 12, the optical unit 13, and the elastic module 14. The elastic module 14 is arranged between the fixture body 11 and the optical unit 13 to provide a buffering space for the optical unit 13. In particular, when the optical unit 13 expands from heat, the increased volume of the optical unit 13 can be received by the elastic module 14 to prevent collision, friction, or other mechanical damages between the light-emitting unit 12 and the optical unit 13. Thus, the service life of the light fixture 1 in the instant disclosure can be lengthened.

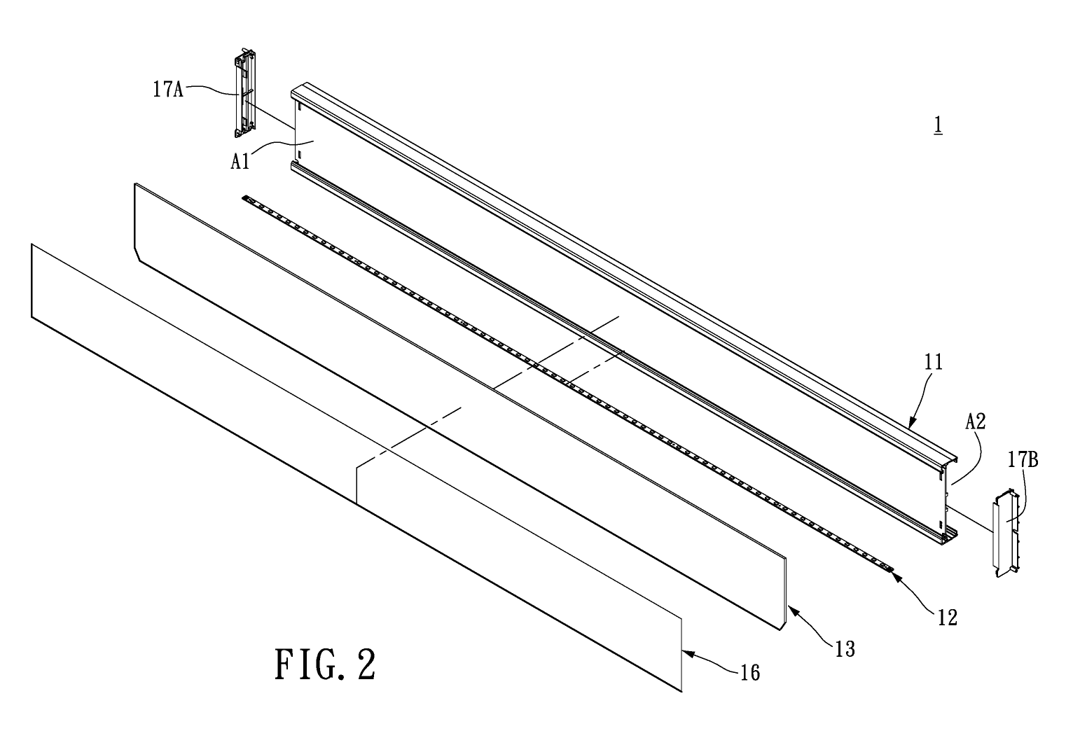

With reference to FIGS. 2 and 3, for the instant embodiment, the fixture body 11 has a first receiving space A1. For instance, the fixture body 11 has a plurality of side plates 111 and an isolating plate 112 to define the first receiving space A1, or for instance, two side plates 111 and one isolating plate 112 are integrally formed as a single unit to define the first receiving space A1, where the cross-sectional view thereof is substantially an I-shaped structure. Therefore, the first receiving space A1 is cooperatively defined by the side plates 111 and the isolating plate 112 on a first side of the isolating plate 112. Furthermore, the first receiving space A1 is used to receive the components including the light-emitting unit 12, the elastic module 14, and the optical unit 13, where the optical unit 13 corresponds to the light-emitting unit 12. In addition, the side plate 111 and the isolating plate 112 can further define a second receiving space A2 for receiving a control unit 15 which is electrically connected to the light-emitting unit 12. Specifically speaking, the fixture body 11 can be formed of a light metal or other material. The side plate 111 and the isolating plate 112 of the fixture body 11 defines the first receiving space A1 and the second receiving space A2, where the light-emitting unit 12, the optical unit 13, and the elastic module 14 are received in the first receiving space A1, while the control unit 15 which controls the signals and provides electricity is received in the second receiving space A2. In other words, the light fixture 1 of the instant disclosure is formed of a modularized structure which can be easily assembled. Preferably, the light fixture 1 further includes a cover 17A and a cover 17B arranged on the two sides of the fixture body 11, where the cover 17A and the cover 17B can be mutually engaged to encase the fixture body 11.

The control unit 15 has a power supply arranged therein to provide electricity to the light-emitting unit 12. The control unit 15 includes, but not limited to, a rectifying module and a filtering module. The rectifying module includes a power input terminal which can input the alternating current, an anti-interfering circuit which avoids electromagnetic interference, a rectifying circuit which rectifies the input power, a power factor circuit which can correct the power factors. On the other hand, the filtering module is electrically connected to the rectifying module, where the filtering module includes pulse width modulation circuit which can modulate the pulse width, a filtering circuit which can filter the power source, and a current stabilizing circuit and etc. Furthermore, the alternating current can be transmitted to the rectifying module then to the light-emitting unit 12 through the filtering module to power the light-emitting unit 12.

For the instant embodiment, the light-emitting unit 12 can be a light emitting diode (LED) or a LED light bar, where the amount thereof is at least one. In addition, the light-emitting unit 12 is disposed on one of the side plates 111 by mean of screwing. However, in another embodiment, the light-emitting unit 12 is disposed on the isolating plate 112. The optical unit 13 provides a specific photonic effect, where the optical unit 13 is disposed on another one of the side plates 111 opposite to the light-emitting unit 12. Specifically speaking, the optical unit 13 is made of a multi-layered photonic film, such as a diffusion plate, a light-guiding plate, and a reflective plate and etc. The optical unit 13 has a first side surface 131, a second side surface 132 and a light-outputted surface 133. The first side surface 131 corresponds to the light-emitting unit 12 (the two components may be/not be in contact). The first side surface 131 is the surface for light emission with respect to the second side surface 132. The elastic module 14 is arranged between the second side surface 132 and the side plate 111 of the fixture body 11, where the amount of the elastic module 14 is not restricted thereto. Therefore, when the control unit 15 outputs current and signals to turn on the light-emitting unit 12, the light of the light-emitting unit 12 will impinge into the optical unit 13 through the first side surface 131. Next, the light will be emitted out of the light-outputted surface 133 after undergoing light-guidance, light-concentration and other photonic effects from the optical unit 13. Eventually, a light fixture 1 which emits light from the side is formed.

Furthermore, the fixture body 11 has an opening 110 which communicates with the first receiving space A1. The light emitted from the light-emitting unit 12, after the photonic effect, is emitted to the outside from the opening 110 to provide light to the users. Preferably, the fixture body 11 further includes a transparent cover 16 arranged on the opening 110, where the transparent cover 16 provides the photonic effects or protects the light-emitting unit 12 and the optical unit 13.

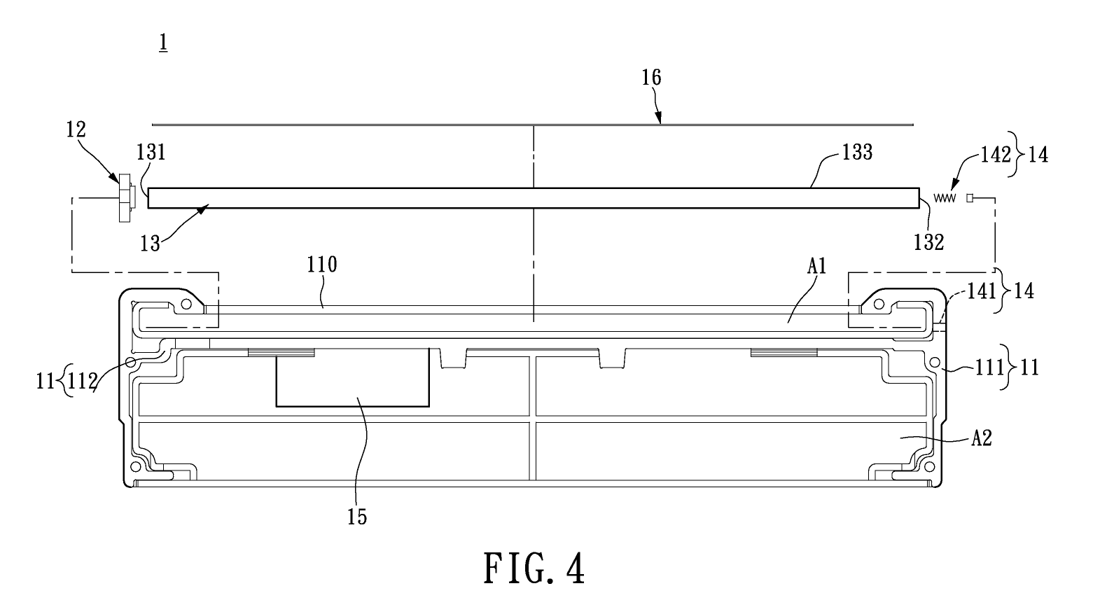

With reference to FIGS. 3A and 4, it is worth noting that when the light-emitting unit 12 is emitting light continuously, the heat produce therefrom may deform the optical unit 13. For instance, the optical unit 13 may expand from heat. Therefore, the elastic module 14 will receive the increased volume, and thereby, the optical unit 13 can be avoided from friction or collision against the light-emitting unit 12. For the instant embodiment, the elastic module 14 includes a through hole 141 formed on the fixture body 11, and an elastic member 142 retained by the through hole 141. The elastic member 142 can be a spring, where one end of the elastic member 142 is connected to the through hole 141m while the other end of the elastic member 142 is connected to the optical unit 13. Therefore, when the optical unit 13 expands due to the heat, the optical unit 13 will depress the elastic member 142, which provides the buffering effect, to avoid damage to the light-emitting unit 12. Furthermore, for another embodiment, the elastic module 14 can be a silicone pad. In other words, a silicone pad is arranged between the second side surface 132 of the light-emitting unit 12 and the fixture body 11, where the silicone pad provides the anti-shock effect, and the hardness thereof is smaller than the light-emitting unit 12. Therefore, when the optical unit 13 expands due to the heat, the optical unit 13 will depress the silicone pad, where the silicone pad can receive the increased volume of the optical unit 13.

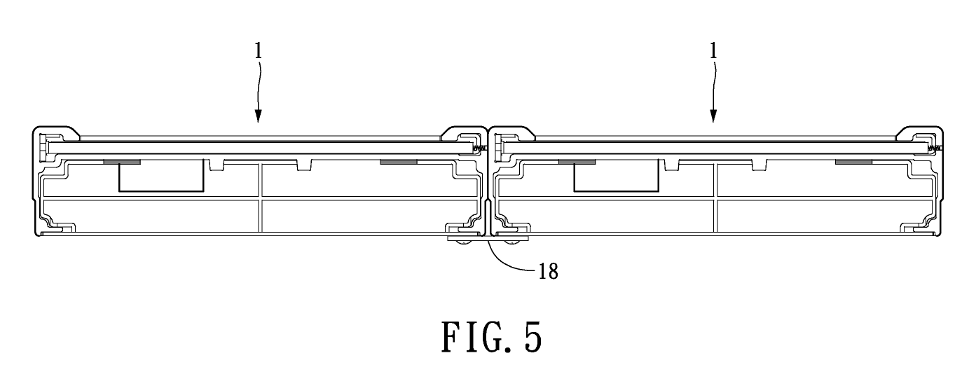

Furthermore, with reference to FIG. 5, the instant disclosure provides a lighting device which is formed from the assembly of the plurality of the aforementioned light fixture 1. Specifically speaking, the light fixture 1 can be assembled by using a plurality of fastening unit 18 to form a lighting device which can brighten up a larger area. For the instant embodiment, the fastening unit 18 is selected from the group consisting of a connecting plate, an engaging plate, a screw member, and a glue member. The fastening unit 18 is used on the adjacent light bodies 11 of the light fixture 1 to form a lighting device having a firmer structure. Furthermore, since the detail of the light fixture 1 is provided in the aforementioned descriptions, therefore, no further illustrations shall be provided herein.

Thus, the instant disclosure utilizes the elastic module 14 to form the buffering space for the optical unit 13 to reduce the possibility of collision therebetween. Particularly, in cases of heat expansion, the elastic module 14 can receive the increased volume of the optical unit 13 to prevent damage to the optical unit 13 when the light-emitting unit 12 expands. Furthermore, the instant disclosure has the following advantages:

1. The light fixture of the instant disclosure is a modularized structure which can be integrally formed as a single unit to provide easy assembly.

The light fixture of the instant disclosure can be assembled from detachable components to provide a larger lighting area.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A light fixture is provided, comprising:
a fixture body having a first receiving space defined therein;
at least one light-emitting unit disposed on the fixture body and accommodated in the first receiving space;
at least one optical unit disposed on the fixture body in the first receiving space configured to receive light emitted by the light-emitting unit; and
at least one elastic module arranged between the optical unit and the fixture body.

2. The light fixture according to claim 1, wherein the light fixture comprises a plurality of side plates and an isolating plate, wherein the first receiving space is cooperatively defined by the side plates and the isolating plate on a first side of the isolating plate, and a second receiving space is cooperatively defined by the side plates and the isolating plate on a second side of the isolating plate.

3. The light fixture according to claim 2, wherein the light-emitting unit is disposed on one of the side plates, and the optical unit is disposed on another one of the side plates opposite to the light-emitting unit, and the light-emitting unit and the optical unit are in correspondence.

4. The light fixture according to claim 2, wherein the fixture body has an opening which communicates with the first receiving space, the light emitted from the light-emitting unit passes through the optical unit to emit to the outside from the opening.

5. The light fixture according to claim 4, wherein the elastic module includes a through hole formed on the fixture body and an elastic member retained by the through hole, the two ends of the elastic member connecting the through hole and the optical unit.

6. The light fixture according to claim 4, wherein the elastic member is a silicone pad.

7. The light fixture according to claim 5, further includes a transparent cover arranged on the opening and a control unit which is in electrical connection to the light-emitting unit and is accommodated in the second receiving space.

8. A lighting assembly comprising a plurality of lighting devices, each lighting device comprising:
a fixture body having a first receiving space defined therein;
at least one light-emitting unit disposed on the fixture body and accommodated in the first receiving space;
at least one optical unit disposed on the fixture body in the first receiving space configured to receive light emitted by the light-emitting unit;
at least one elastic module arranged between the optical unit and the fixture body; and
a plurality of fastening units connecting the fixture bodies of the plurality of lighting devices.

9. The lighting device according to claim 8, wherein the fastening units are arranged on the adjacent light bodies of the light fixture.

10. The lighting device according to claim 8, wherein the elastic module includes a through hole formed on the fixture body and an elastic member retained by the through hole, the two ends of the elastic member connecting the through hole and the optical unit.

11. The lighting device according to claim 8, wherein the light fixture comprises a plurality of side plates and an isolating plate, wherein the first receiving space is cooperatively defined by the side plates and the isolating plate on a first side of the isolating plate, and a second receiving space is cooperatively defined by the side plates and the isolating plate on a second side of the isolating plate.

12. The lighting device according to claim 11, wherein the light-emitting unit is disposed on one of the side plates, and the optical unit is disposed on another one of the side plates opposite to the light-emitting unit, and the light-emitting unit and the optical unit are in correspondence.

13. The lighting device according to claim 11, wherein the fixture body has an opening which communicates with the first receiving space, the light emitted from the light-emitting unit passes through the optical unit to emit to the outside from the opening.

14. The lighting device according to claim 13, wherein each of the light fixtures further includes a transparent cover arranged on the opening and a control unit which is in electrical connection to the light-emitting unit and is accommodated in the second receiving space.
